(19) United States
(12) Patent Application Publication
(10) Pub. No.: US 2016/0350790 A1
(43) Pub. Date: Dec. 1, 2016

(54) SYSTEMS AND METHODS FOR IMPLEMENTING A PROMOTIONAL REWARD PROGRAM

(71) Applicant: TPG Rewards, Inc., New York, NY (US)

(72) Inventor: John GALINOS, New York, NY (US)

(21) Appl. No.: 15/167,126

(22) Filed: May 27, 2016

Related U.S. Application Data
(60) Provisional application No. 62/168,533, filed on May 29, 2015.

(51) Int. Cl. G06Q 30/02

(52) U.S. Cl. CPC G06Q 30/0228; G06Q 30/0233

(57) ABSTRACT

Systems and methods for implementing a promotional reward program using a promotional management apparatus. The system and method can include receiving, using a communication processor of the promotional program management apparatus, a proof of purchase of a product from a mobile device of a consumer; extracting, using a control processor of the promotional program management apparatus, data from the proof of purchase; determining, using the control processor of the promotional management apparatus, a target date associated with the product based on the extracted data; recording in a database of the promotional program management apparatus the target date associated with the product; associating in the database of the promotional program management apparatus the target date associated with the product to the consumer; and transmitting, using the communication processor of the promotional program management apparatus, a promotional reward to the mobile device of the consumer on the target date.

### CROSS-REFERENCE TO PRIOR APPLICATIONS

This application claims priority to U.S. Provisional Application Ser. No. 62/168,533, filed on May 29, 2015, which is hereby incorporated by reference herein in its entirety.

### FIELD OF THE INVENTION

The present disclosure relates generally to promotional reward programs, and more particularly, to a method and apparatus for implementing a promotional reward program whereby rewards are provided to a user based when a product and/or service was purchased.

### BACKGROUND OF THE INVENTION

In order to encourage the purchase of goods and services in the consumer market or to improve the performance of a company's personnel, companies often use promotional reward programs that provide individuals with promotional rewards. The promotional rewards may involve, for example, companies giving away goods or services and/or discounts on goods or services, provided an individual has met certain predetermined criteria. The predetermined criteria could be anything from the purchase of a particular product to the achievement of a particular goal, such as reaching a certain amount of sales over time.

Companies administer these promotional rewards in a variety of ways. For example, upon meeting predetermined criteria, companies may provide individuals with a coupon/promotional number or a physical rebate check, which they could use to redeem their reward and obtain a particular product. However, to receive the promotional reward, an individual may have to wait for a certain amount of time until the reward is validated and sent to the individual. This process can be time-consuming and may pose a problem if the reward is lost, for example, through the U.S. mail. Moreover, an individual may not have the promotional reward available when they want to redeem it. For example, an individual who is already at the movies cannot use his voucher for a free movie ticket if he has left the voucher at home. Certain retail establishments may not process any promotional rewards without having the physical reward available to them.

Accordingly, there is a need for providing a promotional reward program that allows companies to easily manage their promotional reward programs and individuals to instantly obtain promotional rewards for redemption at, for example, a retail establishment.

### SUMMARY OF THE INVENTION

Embodiments of the invention can provide a system and method for implementing a promotional reward program, including, determining whether a user purchased a predetermined product or service, and upon determination, determining the day when the user is likely to need the product and/or service, and providing the user a promotional reward related to the product and/or service within a predetermined amount of time prior to day when the user is likely to need of the product and/or service.

An embodiment of the present invention can provide a method for implementing a promotional reward program system using a promotional management apparatus. The method can include receiving, using a communication processor of the promotional program management apparatus, a proof of purchase of a product from a mobile device of a consumer; extracting, using a control processor of the promotional program management apparatus, data from the proof of purchase; determining, using the control processor of the promotional management apparatus, a target date associated with the product based on the extracted data; recording in a database of the promotional program management apparatus the target date associated with the product; associating in the database of the promotional program management apparatus the target date associated with the product to the consumer; and transmitting, using the communication processor of the promotional program management apparatus, a promotional reward to the mobile device of the consumer on the target date.

According to certain embodiments, the proof of purchase can include a receipt and/or an image of the receipt. Further, the data can include at least one of a date of purchase, a time of purchase, a price of the product, a number of the product purchased, a size of the product, and a quantity of the product, and information regarding previous purchases of the product by the consumer. Additionally, the promotional reward can include a coupon. According to certain aspects, the receiving step can include utilizing a quick response (QR) code and/or transmitting or receiving information using a near-field communication (NFC) chip. Further, the target date can include a target re-purchase date of the product.

Another embodiment of the present invention can provide a promotional reward program system. The exemplary system can include a promotional program management apparatus including a memory, a processor, and a database, where the promotional program management apparatus can be configured to receive a proof of purchase of a product from a mobile device of a consumer; extract data from the proof of purchase; determine a target date associated with the product based on the extracted data; record in the database the target date associated with the product; associate in the database the target date associated with the product to the consumer; and transmit a promotional reward to the mobile device of the consumer on the target date.

According to certain embodiments, the proof of purchase can include a receipt and/or an image of the receipt. Further, the data can include at least one of a date of purchase, a time of purchase, a price of the product, a number of the product purchased, a size of the product, and a quantity of the product, and information regarding previous purchases of the product by the consumer. Additionally, the promotional reward can include a coupon. According to certain aspects, the can be further configured to utilize a quick response (QR) code and/or transmit or receive information using a near-field communication (NFC) chip. Further, the target date can include a target re-purchase date of the product.

### BRIEF DESCRIPTION OF THE DRAWINGS

The features of the present application can be more readily understood from the following detailed description with reference to the accompanying drawings wherein:

FIG. 1 is a flow chart illustrating a method for implementing a promotional reward program, according to one embodiment of the present invention;

FIG. 2 is a flow chart illustrating a method for implementing a promotional reward program, according to another embodiment of the present invention;

FIG. 3 is a flow chart illustrating a method for implementing a promotional reward program by using a cellular phone, according to an embodiment of the present disclosure;

FIG. 4 is a flow chart illustrating a method of obtaining the debit code to purchase movie tickets, according to an embodiment of the present disclosure;

FIG. 5 is a screen shot illustrating the step of allowing the consumer to enter the unique promotion code for verification, according to an embodiment of the present disclosure;

FIG. 6 is a screen shot illustrating the step of allowing the consumer to enter identifying information, according to an embodiment of the present disclosure;

FIG. 7 is a screen shot illustrating the step of providing the consumer with the opportunity to download the debit code for the predetermined product or service, such as a movie ticket, according to an embodiment of the present disclosure;

FIG. 8 is a screen shot illustrating the step providing the consumer with a debit code instantly through the Internet, according to an embodiment of the present disclosure;

FIG. 9 is a screen shot illustrating the step of using the zip code to locate retail establishments participating in the promotional reward program, according to an embodiment of the present disclosure;

FIG. 10 is a flow chart illustrating the implementation of a promotional reward program in real-time, according to an embodiment of the present disclosure;

FIG. 11 is a block diagram illustrating the implementation of a promotional reward program in real-time, according to an embodiment of the present disclosure;

FIG. 12 is a block diagram illustrating a promotional reward program, according to an embodiment of the present disclosure;

FIG. 13 is a flow chart illustrating a method for implementing a promotional reward program, according to an embodiment of the present disclosure;

FIG. 14 is a block diagram illustrating a proof of purchase in the form of a receipt with a unique transaction identifier, such as a bar code, according to an embodiment of the present disclosure;

FIG. 15 is a block diagram illustrating a promotional award program, according to another embodiment of the present disclosure;

FIG. 16 is a flow chart illustrating a method for implementing a promotional reward program, according to an embodiment of the present disclosure;

FIG. 17 is a block diagram illustrating a promotional award program, according to another embodiment of the present disclosure;

FIG. 18 is a flow chart illustrating a method for implementing a promotional reward program, according to an embodiment of the present disclosure;

FIG. 19 is a notional view of a management apparatus according to an embodiment of the present disclosure; and

FIG. 20 is a block diagram illustrating a system for implementing a promotional reward according to an embodiment of the present disclosure; and

### DETAILED DESCRIPTION OF THE PREFERRED EMBODIMENTS

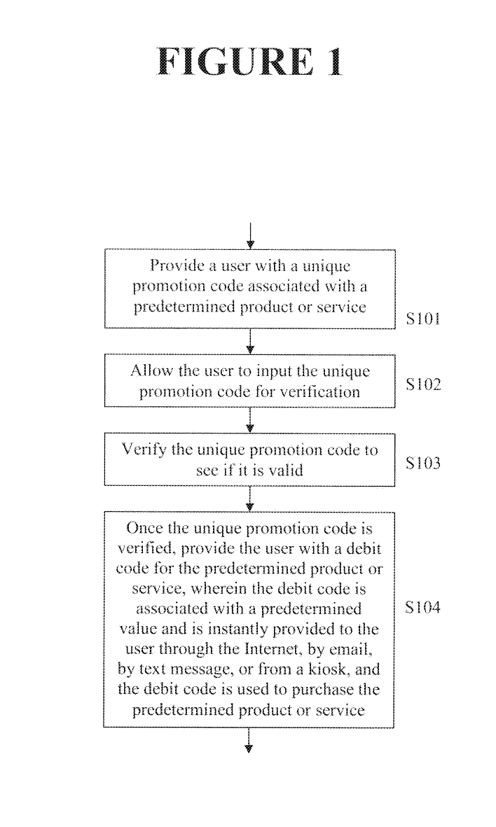

The present invention provides tools for implementing a promotional reward program. FIG. 1 is a flow chart illustrating a method for implementing a promotional reward program, according to one embodiment of the present invention. A consumer is provided with a unique promotion code or identifier that is associated with a predetermined product or service (Step S101). The unique promotion code or identifier can be any combination of numbers, letters, or characters and may be provided to the consumer, for example, in/on the package of a purchased product. As another example, a unique promotion identifier may be an electronically recognizable or identifiable graphic mark or image. As an example, the unique promotion code or identifier can be printed directly on the package or can be part of an insert in the package. According to an embodiment, other methods of distribution may be utilized, such as, email, text message, printing on a coupon, publishing on a website, direct mailings, printing on a receipt, inclusion as part of a new membership welcome kit and/or incentive program services, such as Catalina Marketing®. The predetermined product or service may be, for example, one or more movie tickets, books, music or other products or services that may be purchased in a retail establishment. According to an embodiment, the predetermined product may be purchased and downloaded from a website directly onto a consumer's desktop computer, laptop computer, portable media player or cell phone. For example, the consumer may download one or more movies or songs from an online store.

The consumer inputs the unique promotion code or identifier for verification (Step S102). For example, the consumer can go to a website, and enter the unique promotion code to be validated, or can enter the unique promotion code by email, text message, or at a kiosk. If it is determined that the unique promotion code is invalid or could not be verified, the consumer is provided with a notification indicating that the unique promotion code is invalid. If it is determined that the unique promotion code has already been activated, the consumer is provided with a notification indicating that the unique promotion code has already been activated. If it is determined that the same consumer previously activated the unique promotion code, the consumer is provided with the debit code along with the notification that the unique promotion code has already been activated.

If the validity of the unique promotion code is verified (Step S103), the consumer is provided with a debit code for the predetermined product or service (Step S104). The debit code is associated with a predetermined value and is instantly provided to the consumer through the Internet, by email, by text messaging, or from a kiosk and may be used to purchase the predetermined product or service. For example, the consumer can print the debit code for the predetermined product or service from the Internet, from the email or from the kiosk. According to another embodiment, a consumer may obtain the debit code by using a mobile device and may show the sales clerk the debit code on the screen of the mobile device, for example. The sales clerk can then input the debit code and the transaction can be processed just like a traditional “debit card” or “credit card” transaction.

The consumer may also use the debit code at an online store to purchase the predetermined product or service. If the consumer chooses to utilize the debit code at an online store, he/she may not have to print it. According to an embodiment, the debit code may be a sixteen digit number, such as those used for credit cards and/or debit cards, and/or a bar code.

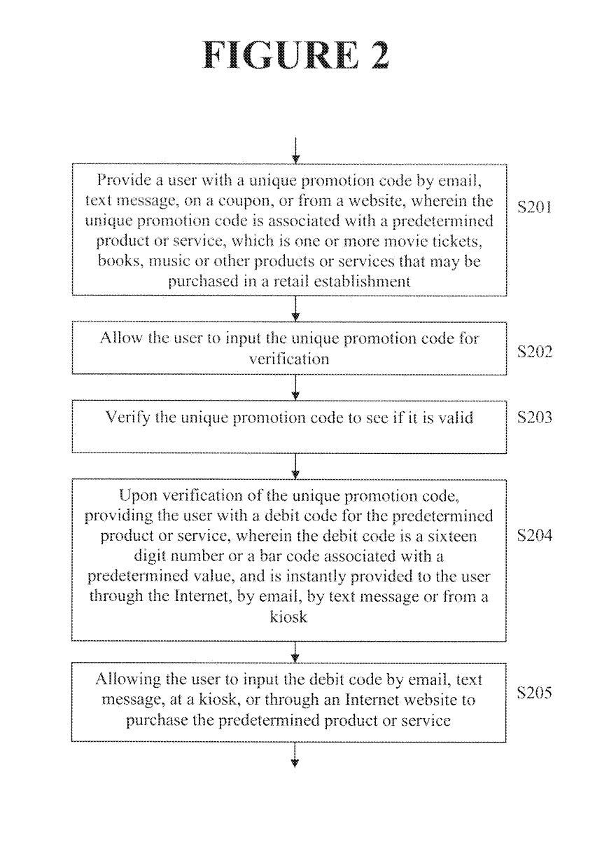

FIG. 2 is a flow chart illustrating a method for implementing a promotional reward program, according to another embodiment of the present invention. A consumer is provided with a unique promotion code by email, text message, on a coupon or from a website, where the unique promotion code is associated with a predetermined product or service, which is one or more movie tickets, books, music or other products or services that may be purchased at a retail establishment (Step S201). The consumer inputs the unique promotion code for verification (Step S202). If the validity of the unique promotion code is verified (Step S203), the consumer is provided with a debit code which may be used for the predetermined product or service, where the debit code is a sixteen digit number or a bar code associated with a predetermined value and is instantly provided to the consumer through the Internet, by email, through text messaging, or from a kiosk (Step S204). The consumer may input the debit code by email, text message, at a kiosk, or through an Internet website to purchase the predetermined product or service (Step S205).

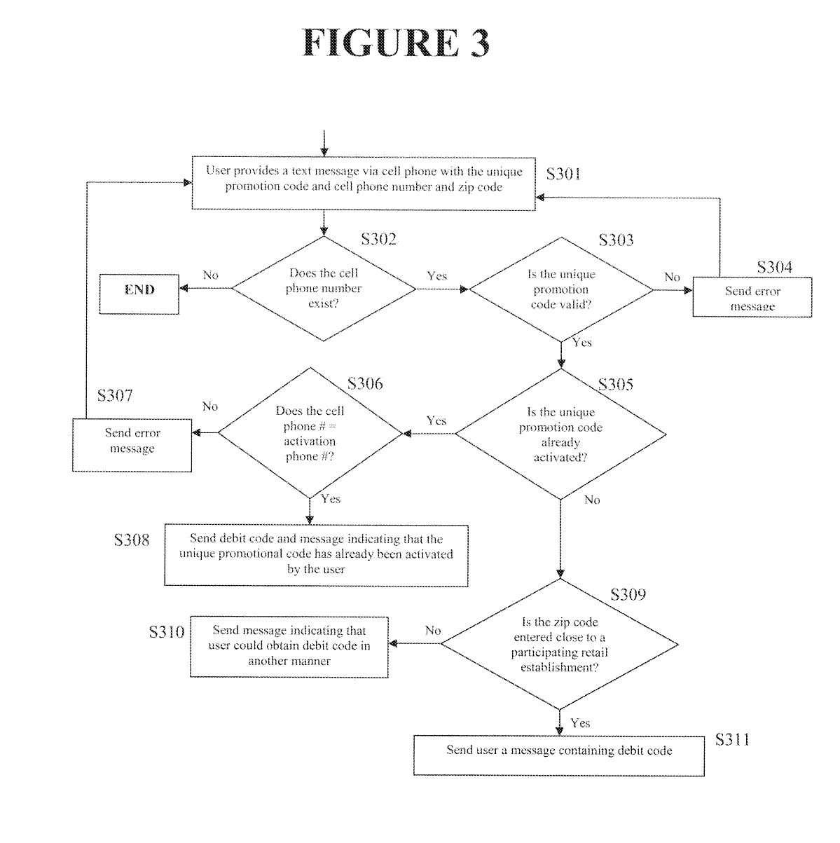

At a retail establishment, a consumer may purchase the predetermined product or service by showing the sales clerk the debit code on the screen, for example, of the consumer's cellular phone. The debit code can be sent, for example, to the consumer's cell phone or mobile device by email or Short Message Service (“SMS”), also known as text messaging. FIG. 3 is a flow chart illustrating a method for implementing a promotional reward program by using a cellular phone, as an example of a mobile device, according to an embodiment of the present disclosure. To obtain the debit code, the consumer can provide a text message including the unique promotion code and his/her cellular phone number and a zip code by text message via the cellular phone (Step S301). According to an embodiment, the zip code may be used to locate the retail establishments that accept debit codes for purchases, closest to the location of the consumer. For example, not every retail location may be able to complete a purchase by utilizing the debit code from the screen of a consumer's cell phone and may require a physical coupon/card/voucher, etc.

The cellular phone number is provided so that the system can respond to the consumer. If it is determined that the cellular phone number is invalid (No, Step S302), the method ends. If it is determined that the cellular phone number is valid (Yes. Step S302), it is then determined whether or not the unique promotion code is valid (Step S303). If it is determined that the unique promotion code is invalid (No, Step S303), then an error message is sent indicating that the code is invalid (Step S304). The consumer can then re-enter the code, if necessary (Step S301). If it is determined that the unique promotion code or identifier is valid, (Yes, Step S303), it is then determined whether or not the unique promotion code or identifier has been previously activated (Step S305). If it is determined that the unique promotion code has been previously activated (Yes, Step S306), the system determines if the cell phone number provided by the consumer in Step S301 is the same as the activation phone number (Step S306). If it is the same number (Yes, Step S306), the consumer is sent a message with the debit code and an indication that the consumer previously activated the unique promotion code (Step S308). If it is not the same number (No, Step S306), an error message is sent to the consumer indicating that the code has been activated by another phone number and the system loops back to Step S301. If it is determined that the unique promotion code has not been previously activated (No, Step S306), the system determines whether the zip code entered in Step S301 is close to a retail establishment location which accepts debit codes for purchases (Step S309). A zip code may be close enough to a participating retail establishment if it is within a reasonable distance, such as 10-15 miles, for example. If the entered zip code is not close enough to such a participating retail establishment (No, Step S309), then the consumer is sent a message indicating that there are no participating retail establishments close enough to the consumer and the consumer can obtain the debit code in another manner (Step S310). For example, the consumer can obtain a printed copy of the debit code by visiting a web-site to print out the debit code. The consumer also may obtain a debit code at a specific store, or may obtain the debit code via mail. If the entered zip code is close enough to a participating retail establishment (Yes, Step S309), then the consumer is sent a message containing the debit code (Step S311). The consumer may then utilize the debit code to purchase a predetermined product or service. For example, if the consumer wants to purchase movie tickets, he/she may show the sales clerk the debit code on the screen of the cell phone. The sales clerk can then input the debit code and the transaction can be processed just like a traditional “debit card” or “credit card” transaction.

According to an embodiment of the present disclosure, the debit code is a sixteen digit number or a bar code that is associated with a predetermined value and may be provided by a bank. For example, a company or any other service may deposit $10,000 into a bank account and instruct the bank or any other service to issue 5,000 debit codes, where each code is associated with a $2.00 value. When a consumer enters the unique promotion code for verification, upon validation, the system will assign one of the 5,000 debit codes associated with a $2.00 value to the consumer. When the debit code is processed at a retail location or an online site for a predetermined product or service in the amount of $2.00, the processor verifies that the bank has the $2.00. The debit code may be processed either by scanning the bar code or inputting the sixteen digit number. The number may be sixteen digits so that it can be utilized by merchants in the same manner as sixteen digit “credit card” or “debit card” numbers to pay for merchandise.

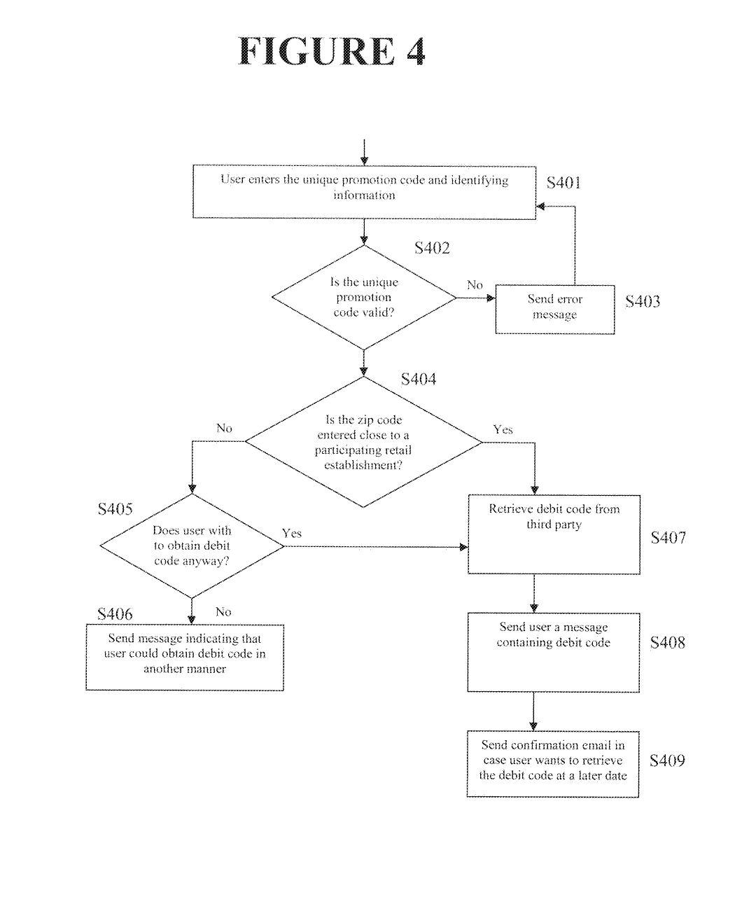

According to an embodiment, the debit code may be used to purchase a predetermined product or service, such as, for example, movie tickets. FIG. 4 is a flow chart illustrating a method of obtaining the debit code to purchase movie tickets, according to an embodiment of the present disclosure. The consumer enters the unique promotion code or identifier and other identifying information (Step S401) either by email, text message, at a kiosk, or through an Internet website. The identifying information comprises one or more of the following: consumer's first name, consumer's last name, consumer's address, consumer's email address, zip code, and/or telephone number. According to an embodiment, the identifying information may be verified and a consumer may be prompted to re-enter the identifying information if it is not verified. For example, identifying information may be invalid if the entered zip code is not five digits.

If it is determined that the unique promotion code is invalid (No, Step S402), then an error message is sent indicating that the promotional code is invalid (Step S403). The error message may be sent by email or text message or displayed at a kiosk or Internet website. The consumer can then re-enter the promotion code, if necessary (Step S401). If it is determined that the unique promotion code is valid, (Yes, Step S402), it is then determined whether the system determines whether the zip code entered in Step S401 as part of the identifying information is close to a participating retail establishment location, such as a participating movie theater (Step S404). A participating retail establishment is any retail establishment which accepts debit codes for purchases. According to one embodiment, use of the debit code is not restricted to one or more particular retail establishments. If the zip code is not close enough to a participating movie theater (No, Step S404), the consumer has the option of obtaining the debit code regardless of the location of the participating movie theaters (Step S405). If the consumer chooses not to obtain the debit code at that time (No, Step S405), the consumer is sent a message indicating that there are no participating retail establishments close enough to the consumer and the consumer can obtain the debit code in another manner (Step S406). This message may be sent by email or text message or displayed at a kiosk or Internet website. For example, the consumer can visit a web-site to print out the debit code, can obtain a debit code at a specific store, or can obtain the debit code via mail. If the entered zip code is close enough to a participating retail establishment (Yes, Step S404) or the consumer decides to obtain the debit code regardless of the location of the participating retail establishments (Yes, Step S405), the debit code is obtained from a third party (Step S407) and is sent to the consumer (Step S408). The consumer may immediately print the debit code from the Internet, from an email or from a kiosk. A confirmation email may be sent to the consumer in case he/she wants to be reminded of the debit code again at a later date (Step S409). According to an embodiment, the debit code may be provided to the consumer on a ticket along with the consumer's name, an expiration date, a listing of the three closest participating theaters, address, and/or email address, etc.

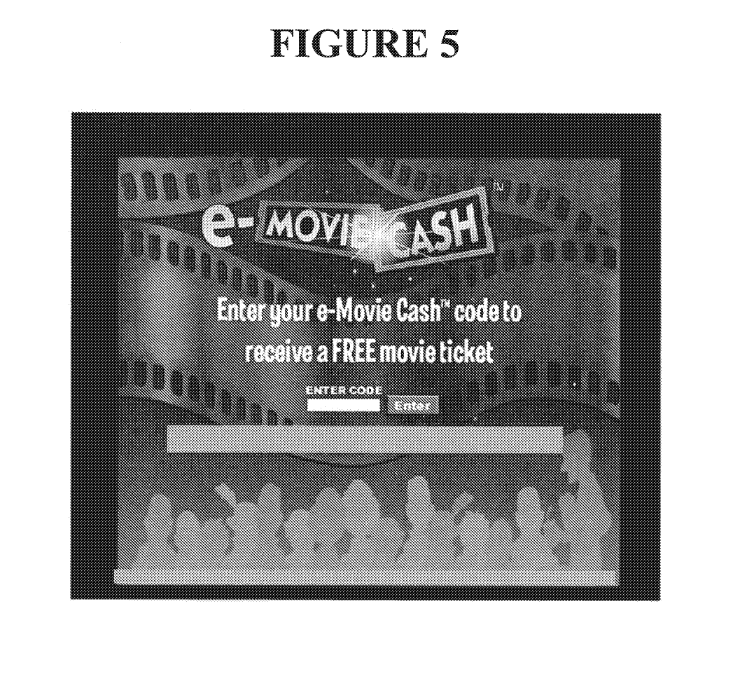

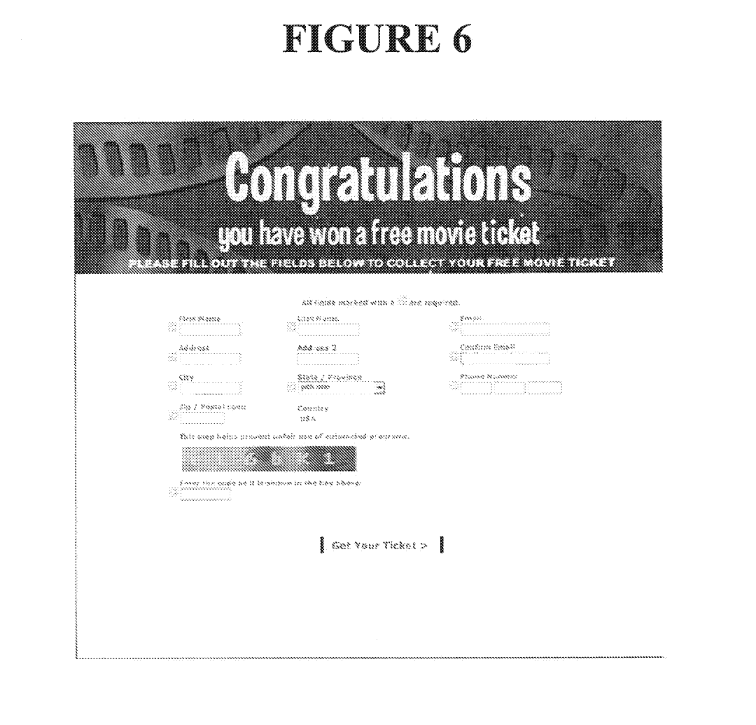

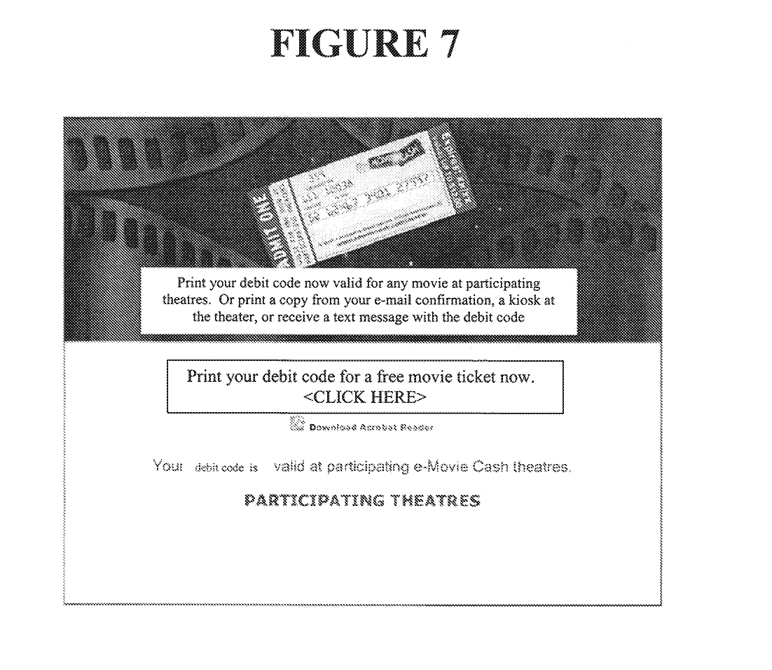

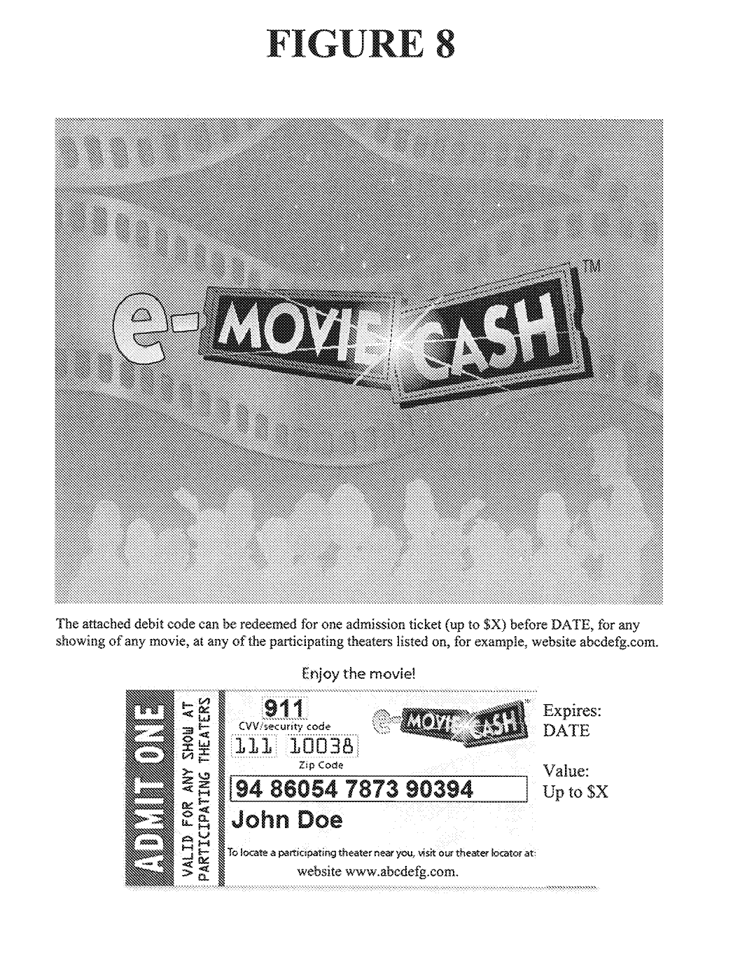

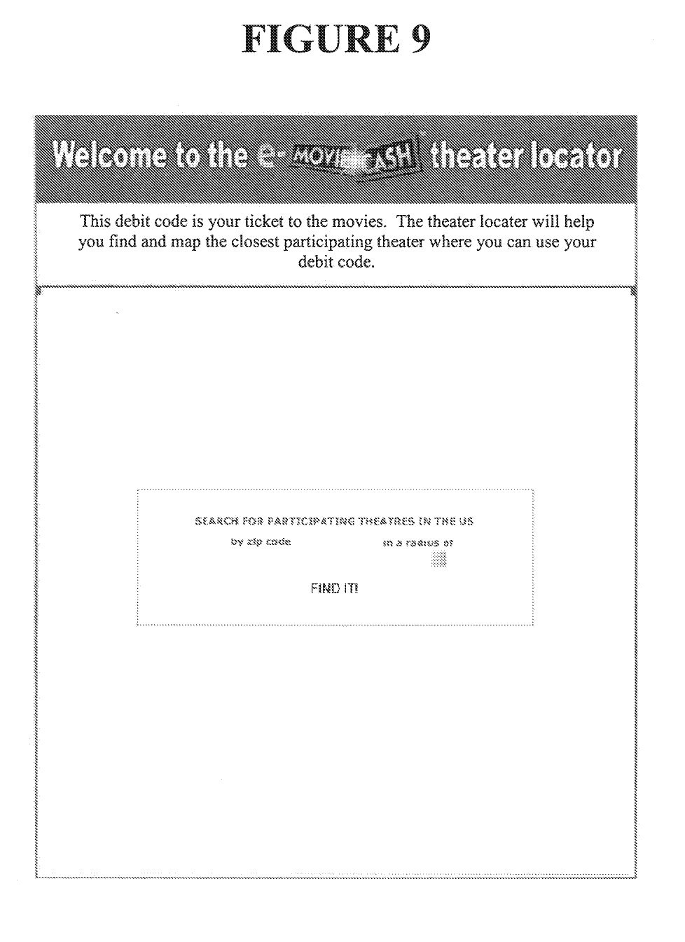

FIGS. 5-7 are screen shots illustrating an implementation of the method for awarding free movie tickets, according to an embodiment of the present disclosure. The screen shot of FIG. 5 illustrates the step of allowing the consumer to enter the unique promotional code for verification. The screen shot of FIG. 6 illustrates allowing the consumer to enter identifying information. The screen shot of FIG. 7 illustrates the step of providing the consumer with the opportunity to download the debit code for the predetermined product or service, wherein the debit code is associated with a free movie ticket and can be instantly downloaded and/or printed by the consumer from a PDF reader. Alternatively, as illustrated at the bottom of FIG. 7, the consumer may choose to obtain a list of retail establishments that accept debit codes for purchases in close proximity to the location of the consumer (click on “Participating Theaters”). For example, the screen shot of FIG. 9, according to an embodiment, illustrates the step of allowing the consumer to input a zip code to locate retail establishments, namely, movie theaters, participating in the free movie ticket program. If the consumer determines that there are no participating theaters close enough, he/she may opt to obtain the debit code in another manner, for example, the consumer can visit a web-site to print out the debit code, can obtain a debit code at specific store, or can obtain the debit code via mail. If the consumer determines that there are participating theaters close enough, he/she may obtain the debit code instantly through the Internet. FIG. 8 is a screen shot illustrating the step of providing the consumer with a debit code instantly through the Internet, after it is downloaded in FIG. 7. According to an embodiment, the consumer may also obtain the debit code by email, by text message, or from a kiosk.

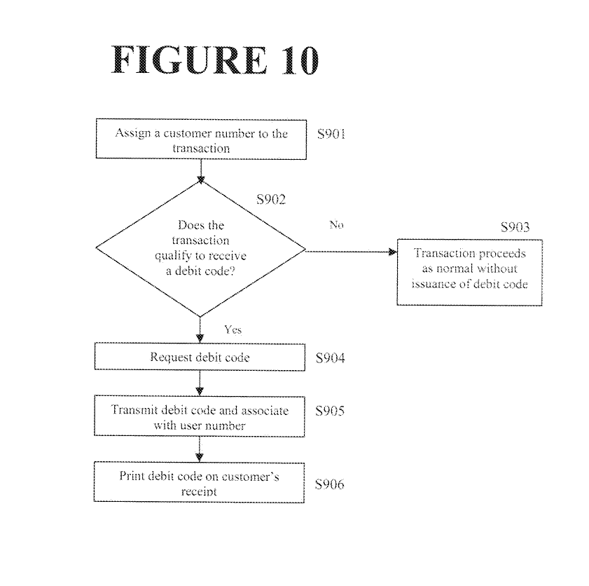

According to another embodiment of the present disclosure, the consumer may obtain the debit code reward directly on a receipt in real-time, for example, at a point of sale in connection with a purchase, without having to obtain or transmit a unique promotion code. FIG. 10 is a flow chart illustrating the implementation of a promotional reward program in real-time, according to this embodiment. At a point of sale (for example, at the cashier/check-out kiosk of a supermarket, department store, drug store, restaurant, through the Internet, or any other means, entity or business that provides goods and/or services for sale) in connection with a purchase, a customer number is assigned to the transaction (Step S901). A point of sale may also include any location where a consumer can purchase goods or services, such as, a retail establishment, the home of a person purchasing goods through the Internet. According to an embodiment, the customer number may be the customer loyalty program number or any other number that is unique to the customer. It is then determined whether or not a customer transaction or purchase qualifies to receive a reward, such as a debit code (Step S902). For example, the purchase of a predetermined product and/or service, a total purchase amount greater than a predetermined amount, or membership in the store's customer loyalty program may qualify the customer to obtain a debit code. If it is determined that the transaction does not qualify for the debit code (No, Step S902), the transaction proceeds as normal, with the customer paying for the goods and/or services and obtaining a receipt without a debit code (Step S903). However, if it is determined that the customer or purchase qualifies for the debit code (Yes, Step S902), a debit code may be requested by the point of sale (Step S904). The debit code may be requested from, for example, a debit code issuer. The debit code issuer may be one or more of the following: the point of sale retail establishment, a customer loyalty program, an advertising agency, a coupon code issuer (for example, Catalina Marketing), a manufacturer, and/or any third party which is in the business of issuing debit codes. The debit code is then transmitted to the requesting entity, for example, the point of sale. (Step S905). For example, the purchase may be assigned a transaction or customer number and when the debit code is received from the debit code issuer, it may be associated with the data file for that transaction or customer number.

According to an embodiment, the debit code can be instantaneously provided to the consumer through the Internet, by email, by text message, on a coupon, from a kiosk, or any other means of instantaneous communication. For example, the debit code, according to an embodiment, may be printed on the customer's receipt (Step S906). When a customer is ready to use the debit code, it can be obtained from the receipt. According to an embodiment, the debit code is a sixteen digit number or a bar code associated with a predetermined value and may be used to purchase one or more products and/or services. For example, the debit code may be used to purchase one or more movie tickets.

One or more debit codes may reside on a server at the point of sale or may be transmitted in groups from the debit code issuer to the point of sale. According to an embodiment, the promotional reward program may be implemented internally through a server residing at the store or retail establishment. When requested, the store server may issue the debit code to the requesting entity such as the point of sale, for example, a cash register. The debit code may then instantaneously be provided to the consumer, for example, by printing it on a coupon.

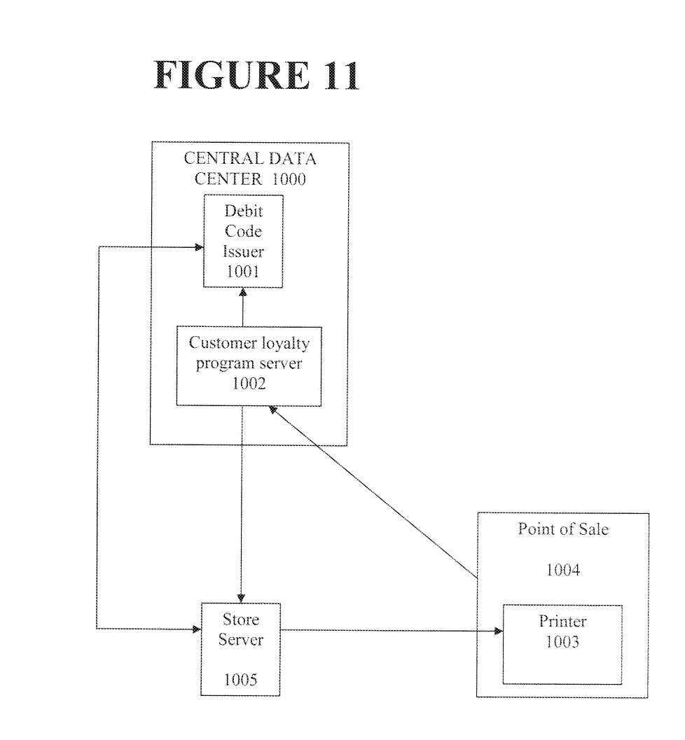

FIG. 11 is a block diagram illustrating the implementation of a promotional reward program in real-time, according to another embodiment. A customer approaches a point of sale 1004, for example, a checkout lane of a store, to purchase one or more products and/or services. The point of sale 1004 may assign the customer a customer number. The point of sale 1004, communicates with the customer loyalty program server 1002 to determine whether the customer qualifies for a debit code. For example, using the customer number, the customer loyalty program server 1002 can determine if the customer is eligible to qualify for any offers based on past or present purchases. If it is determined that the customer qualifies for the debit code, the customer loyalty program server 1002 requests a debit code from the debit code issuer 1001. According to an embodiment, the customer loyalty program server 1002 may alert the store server 1005 that the consumer is qualified for a debit code so that it knows to wait for a receipt. If it does not receive the debit code in a predetermined amount of time, the store server 1005 may notify the customer loyalty program server 1002. According to an alternate embodiment, the store server 1005 may request the debit code from the debit code issuer 1001. Both the debit code issuer 1001 and the customer loyalty program server 1002 may be located in a central data center 1000 in a remote location or may be located in separate remote locations, or may be located on site. The debit code issuer 1001 transmits the debit code to the store server 1005, and the store server 1005 transmits the debit code to a printer 1003 located at the point of sale 1004. The printer 1003 prints the debit code on, for example, a receipt, which is then given to the customer. According to another embodiment, the debit code can be instantly applied to the transaction without having to print it.

According to an embodiment, a proof of purchase can be validated at the moment a consumer receives the proof of purchase. A proof of purchase can be any indication that a particular product or item was purchased or obtained according to the rules of the promotion. Examples of proofs of purchase may include receipts, codes or identifiers printed on receipts, “Paid” stickers adhered to purchased products, a printed item placed inside a sealed product package, et cetera. For example, a promotional program may be available that allows a consumer to obtain a reward, such as, free movie tickets, if he/she purchases two boxes of cereal during a promotional period. The consumer can take a photograph using a camera feature of a mobile device, such as a cell phone, of a receipt or a code printed on the receipt showing that two cereal boxes were purchased and when they were purchased. Upon verification that the two cereal boxes were in fact purchased and were purchased during the promotional period, the consumer can be provided with his/her reward, i.e., free movie tickets.

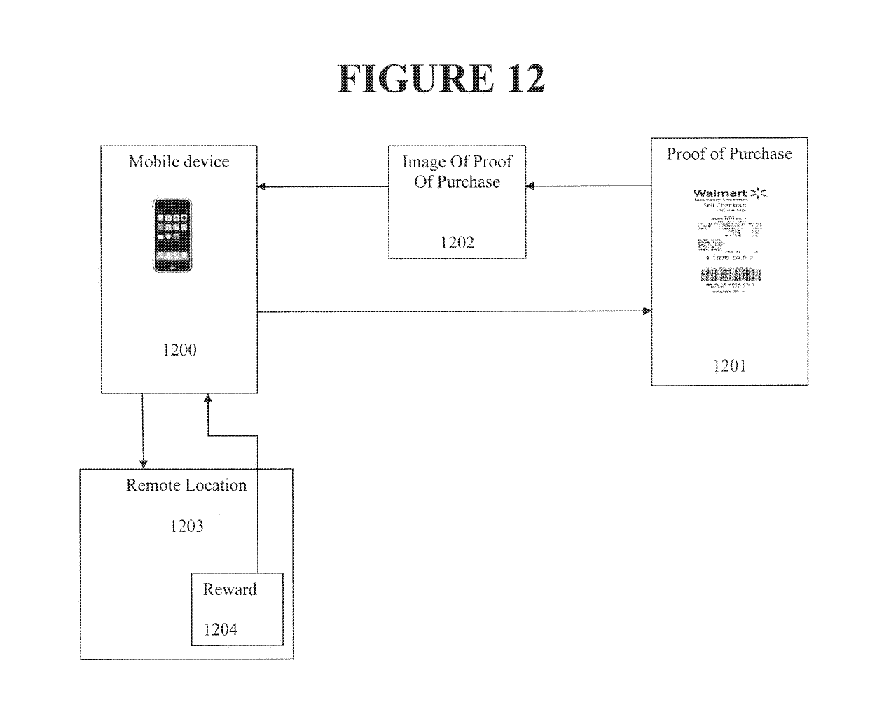

FIG. 12 is a block diagram illustrating a promotional reward program, according to an embodiment of the present disclosure. A consumer transmits one or more images 1202 of the proof of purchase 1201 wirelessly to a remote location 1203 through a mobile device 1200. Alternatively, the image may be transferred by a wired connection, such as a land-line. The one or more images may be captured by the consumer prior to transmission, by using, for example, a camera function of the mobile device. According to an embodiment, the remote location may be one or more computers, servers or other processing or managing apparatuses that are located in the store where the customer is shopping or may be located in another area. If it is determined that a consumer or purchase is eligible for a reward 1204, the remote location instantly 1203 transmits to the consumer's mobile device 1200 a reward 1204. The mobile device 1200 can be a handheld device, a cell phone device, an iPhone, a Blackberry, a handheld computer, scanner, camera, personal digital assistant, portable media player, smartphone, personal navigation device, or any other computing device. According to another embodiment, a consumer can transmit an SMS or text message containing the information on the proof of purchase 1201 or a proof of purchase code or other indication without having to take or transmit the one or more images of the proof of purchase.

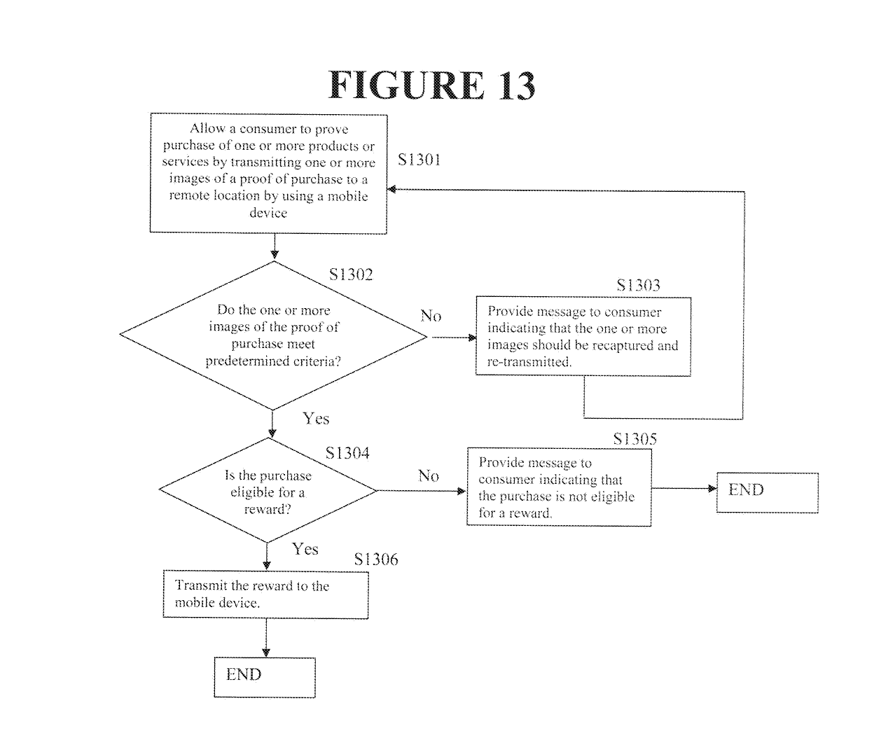

FIG. 13 is a flow chart illustrating a method for implementing a promotional reward program, according to an embodiment of the present disclosure. In order to prove the purchase of one or more products or services, a consumer may transmit one or more images of a proof of purchase directly to the managing apparatus for verification by using a mobile device (Step S1301). For example, the one or more images may be transmitted via SMS messaging, also known as text message, to a unique text number of the managing apparatus or may be sent by email to an email address associated with the managing apparatus. The unique text number or email address may also be associated with a particular reward program or a particular customer loyalty account number.

The proof of purchase, as discussed above, can be a receipt, an invoice, shipping document, or any other document or indication that would prove that a consumer obtained or purchased a particular product or service according to the rules of the promotion. If the proof of purchase is too long to capture in a single image, the proof of purchase may be sectioned, for example, by folding the proof of purchase, and each section may be captured in a separate image. Alternatively, if the proof of purchase includes a unique transaction identifier, such as a bar code or other number, a consumer may capture and transmit an image of the unique transaction identifier, without having to capture and transmit images of the entire proof of purchase. A consumer can obtain or purchase a particular product or service by paying for it, or by using a gift card or a store credit, for example. The transmission of the one or more images of the proof of purchase directly by the consumer to a remote location is useful, for example, in situations where a retailer does not have the capability to print a unique promotion code on a product package or insert a unique promotion code as part of a product package. Other information may be transmitted to a managing apparatus, in addition to a proof of purchase. Examples of other information include item identifiers, et cetera.

A unique transaction identifier may be any code, image, or the like that indicates a particular transaction. Such unique transaction identifier may be associated with any one or more of a customer identity, a customer loyalty account number associated with a transaction, a retail location and/or cash register at which the transaction took place, a clerk identification of the sales clerk making the transaction, an identification and/or quantity of the products purchased, an identification of the date and/or time of the transaction, a total amount of the transaction, et cetera. A transaction identifier can also be used as a proof of purchase.

An item identifier may be any code, image or the like that indicates a product or service. The product or service, however, need not be purchased or obtained by a customer according to one embodiment of the present invention. Instead, a customer may capture an image of an item code at a display in a retail store without actually purchasing the product or service. In one example, item identifiers could be scattered on product displays or advertisements throughout a retail location as a part of a “scavenger hunt” type promotion encouraging customers to explore a retail store.

Once the one or more images of the proof of purchase and/or item identifier are transmitted by the consumer through the mobile device to a remote location, it can be determined if the one or more images of the proof of purchase meet predetermined criteria and whether the consumer is eligible for an award according to the rules of the particular reward program for which the consumer is submitting the proof of purchase (Steps S1302 & 1304).

According to an embodiment, the predetermined criteria may include whether the one or more images are of a suitable resolution, whether the one or more images includes the information necessary to determine eligibility, such as the date of the transaction, a unique product identifier such as a serial number, a UPC and/or SKU, a unique transaction identifier, or other information, et cetera. The step of determining whether the one or more images of the proof of purchase meet predetermined criteria may further comprise determining whether the one or more images are of a suitable resolution to enable electronic character recognition, i.e. whether the one or more images may be electronically translated into alphanumeric characters. If it is determined that the one or more images of the proof of purchase or item identifier do not meet predetermined criteria (No, Step S1302), for example, if the one or more images of the proof of purchase are blurry or not of a suitable resolution, a message is provided to the consumer instructing the consumer to re-capture and to re-transmit the one or more images (Step S1303). The message also may indicate why the one or more images are not, for example, of a suitable resolution. For example, the image may be too shadowy or the environment where the image is taken may not be adequately lit. This verification may be conducted by one or more of a computer, a mobile device or a human operator. Alternatively, if the electronic recognition fails, before the message is sent, the image may be sent to a human operator who may manually verify that the one or more images of the proof of purchase or item identifier do not meet the predetermined criteria, for example, are not a suitable resolution. If the predetermined criteria are not met, the method then loops back to Step S1301 and the process may start again.

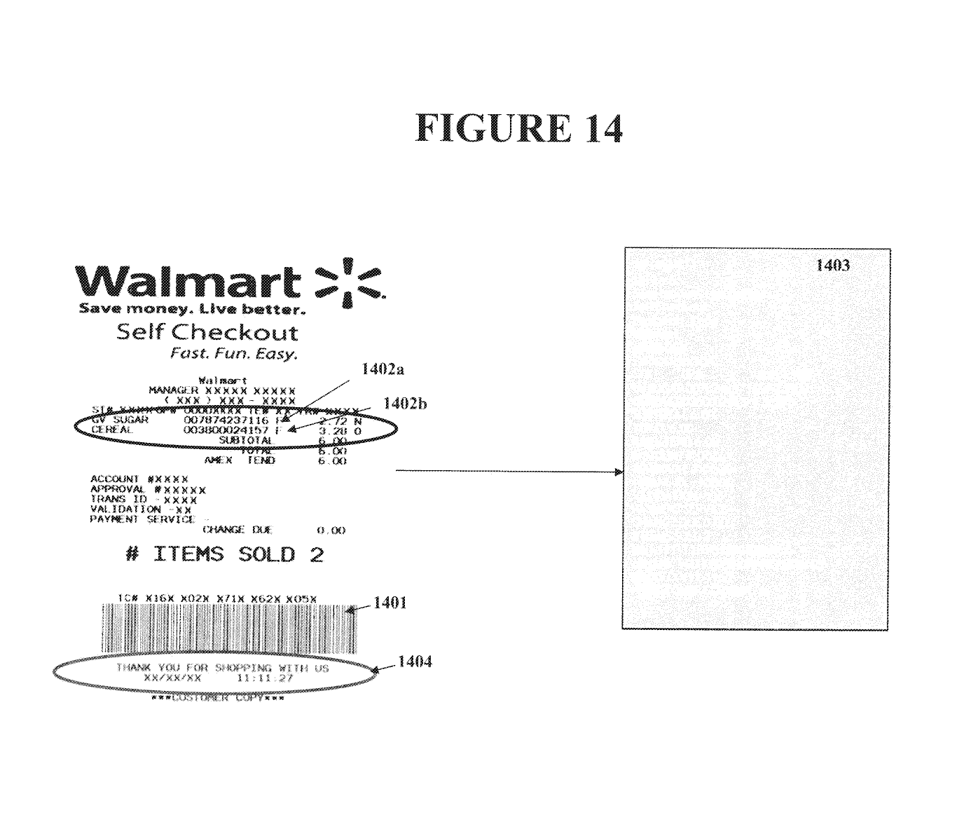

In order to determine whether the consumer or purchase is eligible for a reward (Step S1304), the method and system determines whether the consumer or purchase meets one or more eligibility criteria, such as if the proof of purchase was previously validated, if the consumer has purchased the one or more products or services eligible for the reward during the promotional period, if all required item identifiers have been transmitted for a reward, et cetera. In one example, in order to make this eligibility determination, a proof of purchase such as a unique transaction identifier in the form of, for example, a bar code located on a receipt, is identified. The unique transaction identifier may be identified by digitizing, or electronically recognizing alphanumeric characters of, the information located on the proof of purchase through prior art methods and systems, as shown in FIG. 14.

Electronic image recognition is a process by which an image or graphic mark is translated into alphanumeric characters representative of the image or graphic mark. For example, electronic image recognition may translate an image of a bar code into a series of numeric digits. Electronic image recognition may be performed by the mobile device prior to transmitting the unique transaction identifier, other proof or purchase, or item identifier to a management apparatus or may be performed by a management apparatus after receiving the image transmitted by a mobile device.

FIG. 14 is a block diagram illustrating a proof of purchase in the form of a receipt with a unique transaction identifier, such as a bar code. A unique transaction identifier, such as a bar code 1401 located on a receipt, may be used as a means for identification of the particular transaction by a retailer. For example, by scanning or inputting the bar code 1401, a retailer could easily obtain a list of all the goods and/or services that were purchased by a consumer in a given transaction, without having to separately scan or input the stock-keeping unit (“SKU”) numbers for each of the individual goods and/or services 1402. The receipt, for example, may be digitized 1403 so that the text can be electronically read by methods and systems well known in the art.

According to an embodiment, the unique transaction identifier can be compared to a database containing one or more previously recorded records of one or more unique transaction identifiers that were previously validated in order to determine whether the proof of purchase was previously validated. The unique transaction identifier is associated with a data file stored on a server which contains the SKU and/or UPC numbers or other product identifiers of the products which were purchased during the transaction identified by the unique transaction identifier. The data files may be stored, for example, on a server of the retail store. According to another embodiment, SKU and/or UPC numbers for the one or more eligible products and/or services 1402 are reviewed along with the date of the transaction 1404 in order to determine whether such purchases are eligible for the reward.

If there is no unique transaction identifier indicated on the proof of purchase, the system may limit reward redemptions by restricting rewards to a single reward per mobile device, mobile telephone number, or email address used by the consumer. For example, if a consumer transmits a proof of purchase from her cell phone, the system receiving the proof of purchase will determine whether the proof of purchase was previously validated by comparing the unique transaction identifier to a database including records of previously validated unique transaction identifiers, as described above. Alternatively, if the proof of purchase does not contain a unique transaction identifier, the system may verify whether the cell phone number transmitting the proof of purchase has previously transmitted a proof of purchase for the same reward program, and may deny the reward if the verification is positive.

If it is determined that the consumer is not eligible for the reward (No, Step S1304), the consumer is provided with a message transmitted to the mobile device indicating that the consumer is not eligible for the reward and the process ends (Step, S1305). If it is determined that the one or more images of the proof of purchase meet the predetermined criteria and if the consumer or purchase is eligible for a reward (Yes, Steps S1302, 1304), the consumer is instantly provided with the reward by transmission of the reward to the mobile device (Step S1306), for example, by text message. According to an embodiment, the reward is a debit code associated with a predetermined value and is usable to purchase one or more products and/or services, or is a credit that can be applied to pay one or more of the consumer's bills. For example, the reward may be used to pay a consumer's cell phone bill or may be applied as a credit towards the cell phone bill.

According to an embodiment, if a consumer is unable to obtain an image of the proof of purchase or the unique transaction identifier or a clear image thereof, the consumer can simply send in a text message the relevant information to the remote location using the mobile device. For example, the consumer can send a text message through the mobile device to the program management apparatus that contains a proof of purchase such as, for example, a unique transaction identifier.

According to another embodiment, the present invention may be used to implement various contests and promotional programs that allow consumers to transmit images of an item identifier that may be located on one or more products, used in connection with one or more services or used on one or more product displays by using the mobile device. A product display is a display that may be used to advertise a particular product or service. For example, at a retail establishment, end-of-aisle displays, stand-alone displays, or point-of-sale displays can be used to showcase different products or services, such as, for example, supermarket products or services, or massage/nail services, automobile repair services, etc. In exchange for transmitting the item identifier, the consumer is provided with a reward, for example, a coupon that is applicable to the purchase of one or more of the products and/or services corresponding to the item identifier transmitted.

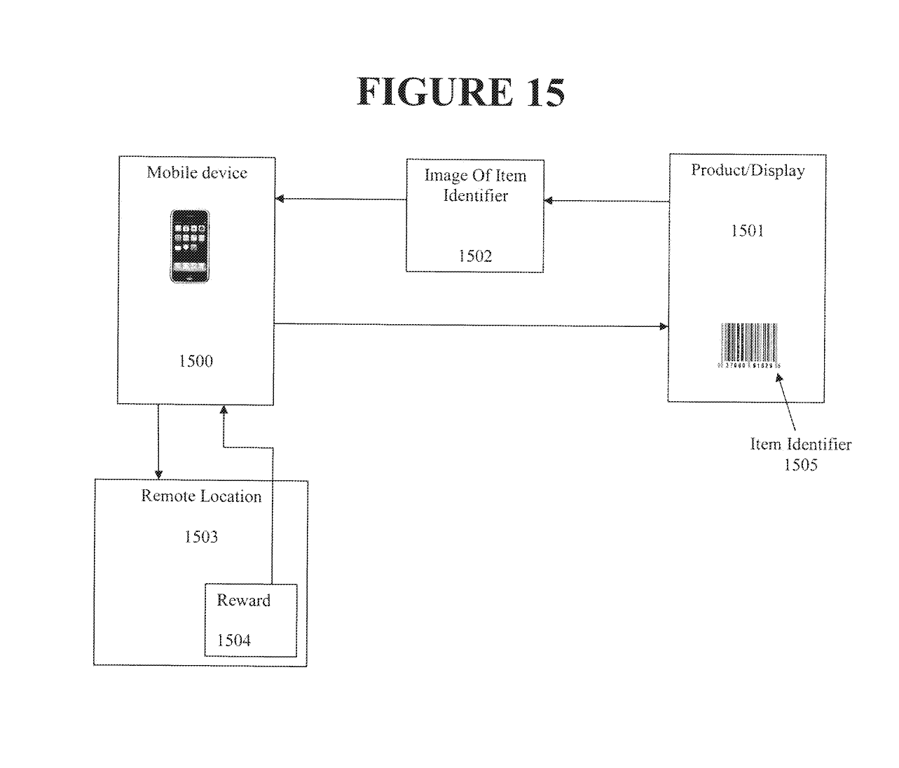

FIG. 15 is a block diagram illustrating a promotional award program, according to another embodiment of the present disclosure. An item identifier 1505 is provided on one or more products or displays 1501. The item identifier can be any number, code, or image that is unique to the product or display (for example, a display associated with a service) or any other identifier that can be used to identify the product, display, such as, for example, a bar code. A consumer transmits one or more images 1502 of the item identifier 1505 or transmits a text message containing the item identifier 1506 associated with one or more products/displays 1501 to a remote location 1503 by using a mobile device 1500. If it is determined that a consumer is eligible for a reward 1504, the remote location 1503 transmits to the consumer's mobile device 1500 a reward 1504.

For example, the item identifier 1505, such as a bar code, may be placed on a product package or movie studio billboard. A promotional sweepstakes could be advertised which would provide that the first 100 people to text the bar code or transmit the image of the bar code on the product package or movie studio billboard, for example, could win a reward, such as a debit code associated with a predetermined value which is usable to purchase one or more products and/or services, such as free movie tickets, or a credit that can be applied to pay one or more of the consumer's utility or other bills. The promotional sweepstakes could be advertised on the package of the product itself, inside the package, on a display, or in connection with an advertisement relating to the product or service. The advertisement may be a written advertisement or may be available on the Internet, on television or on the radio.

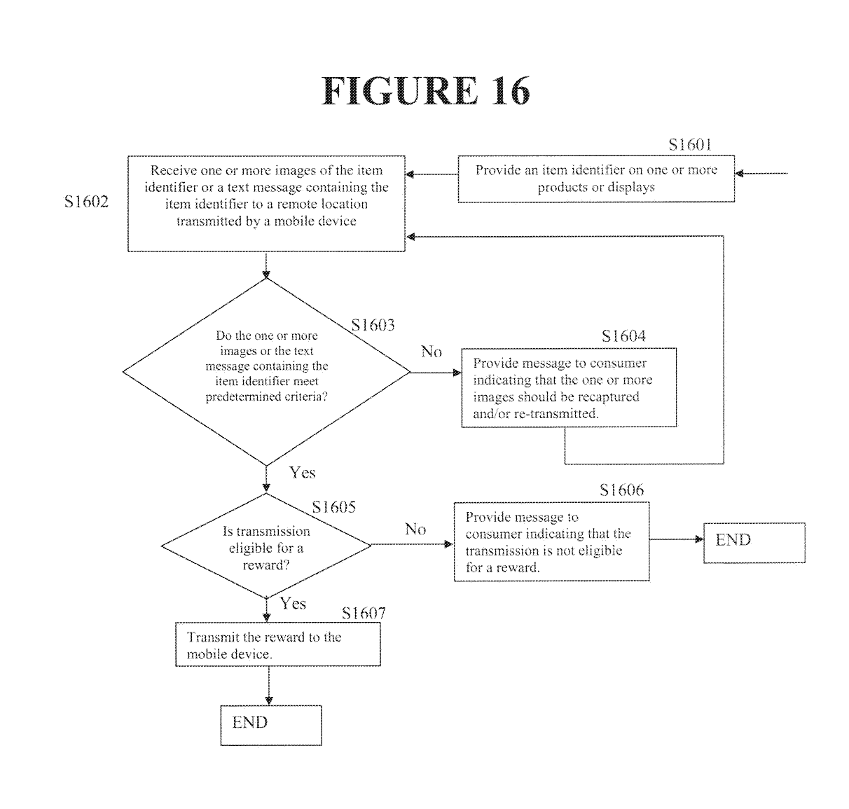

FIG. 16 is a flow chart illustrating a method for implementing a promotional reward program, according to an embodiment of the present disclosure. An item identifier is provided on one or more products or displays (Step S1601). A consumer may transmit one or more images of the item identifier or a text message containing the item identifier directly for verification to a remote location by using a mobile device (Step S1602). Once the one or more images of the item identifier or a text message containing the item identifier are transmitted by the consumer through the mobile device to a remote location, it can be determined if the one or more images of the item identifier or the text message containing the item identifier meet predetermined criteria and whether the consumer is eligible for an award (Steps S1603 & S1605). If it is determined that the one or more images of the item identifier or the text message containing the item identifier does not meet predetermined criteria (No, Step S1603), for example, if the one or more images are not of a suitable resolution, or, as another example, if the text message containing the item identifier contains an incorrect number of digits, a message is provided to the consumer indicating that the one or more images should be re-captured and/or re-transmitted (Step S1604) or the text message should be typed again and re-transmitted. This verification may be conducted by one or more of a computer, a mobile device or a human operator. The message also may indicate why the one or more images are not, for example, of a suitable resolution. For example, the image may be too shadowy or the environment where the image is taken may not be adequately lit. Alternatively, if an electronic recognition operation fails, before the message is sent, the image may be sent to a human operator who may manually verify that the one or more images of the item identifier do not meet the predetermined criteria, for example, are not a suitable resolution. If the images or text message does not meet the predetermined criteria, the method then loops back to Step S1602 and the process may start again.

In order to determine whether the consumer is eligible for a reward (Step S1605), the method and system determines whether the transmission from the consumer has met all the requirements for the promotional program, for example, whether the consumer has transmitted an image of a valid item identifier, such as a bar code (or has provided a valid unique promotional identifier, such as a bar code via text message), i.e., whether it is the item identifier, such as a bar code, for the relevant product or display, and whether the transmission is, for example, one of the first 100 people to text an image of the item identifier. If it is determined that the transmission is not eligible for a reward (No, Step S1605), a message is provided to the consumer indicating the consumer is not eligible for a reward (Step S1606), and the process ends. If it is determined that the one or more images of the item identifier or the text message containing the item identifier meet the predetermined criteria and if the transmission is eligible for a reward (Yes, Steps S1603, S1605), the consumer is instantly provided with the reward to the mobile device (Step S1607), for example, by text message.

According to an embodiment, the reward may be a debit code associated with a predetermined value and may be usable to purchase one or more products and/or services, or is a credit that may be applied to pay one or more of the consumer's/user's utility or other bills. According to another embodiment, the reward may be information about the product or service comprising recipes, tips about how to use a product or to obtain a service, or one or more coupons relating to the product or service. The one or more coupons relating to the product or service may be assigned to an account of a customer loyalty program which is associated with the consumer so that the consumer may use such coupons through the customer loyalty program in a manner that is well-known in the art.

According to another embodiment, the item identifiers provided on product packages or displays and/or proofs of purchase can be used in connection with a customer loyalty program for a retailer in order to obtain rewards or information through the customer loyalty program. Customer loyalty programs are marketing tools that encourage consumers to buy from specific retail establishments by issuing rewards. A retail establishment, for example, may issue a customer loyalty program card and/or account number to a consumer who can present the card and/or account number in connection with a purchase, in order to receive a discount on a current purchase, or other rewards, including rewards that can be used for future purchases. Such customer loyalty programs generally assign a customer loyalty account number to a customer, and establish an account associated with that customer loyalty account number which maintains information concerning that customer's purchases and spending habits in a database on a server for the customer loyalty program.

A customer or consumer can transmit one or more images of an item identifier or proof of purchase, such as a bar code, or a text message containing the item identifier or proof of purchase, such as a bar code, along with one or more images or a text message containing the customer's customer loyalty program account number to a remote location or program management apparatus by using a mobile device. In response, the consumer may receive information about the product or service identified by the item identifier or proof of purchase or any other product or service and/or may also receive a promotional credit or coupon relating to the product or service identified by the item identifier or proof of purchase or any other product or service through the customer loyalty program. For example, the promotional credit or coupon can be automatically sent or assigned to the customer/user's loyalty account by the management apparatus so that the customer can use it immediately in connection with a current or future purchase.

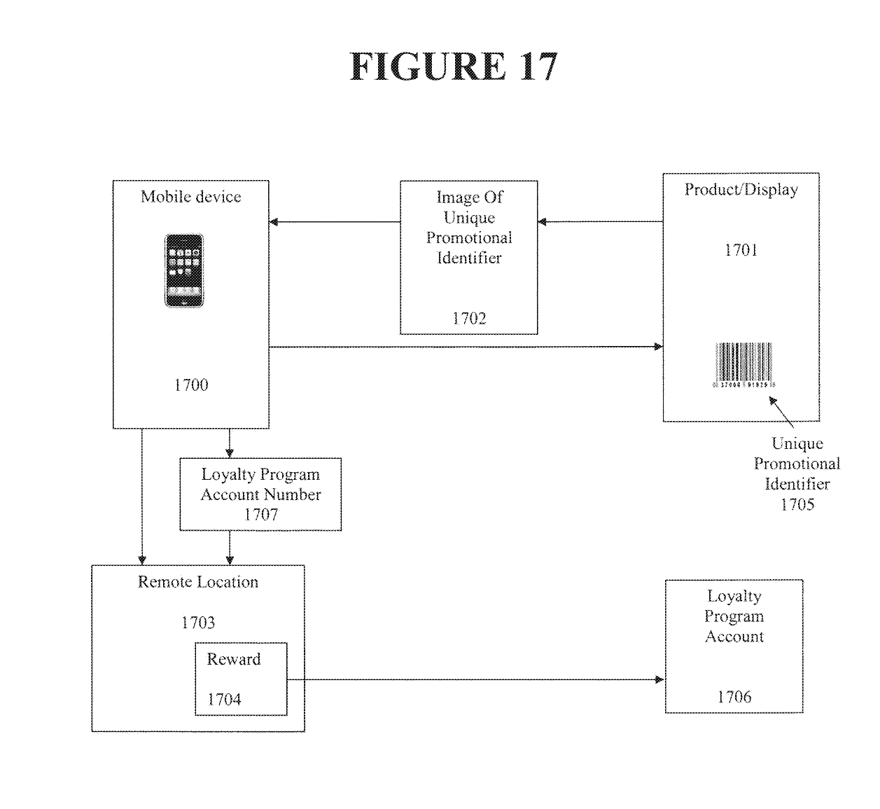

FIG. 17 is a block diagram illustrating a promotional award program, according to another embodiment of the present disclosure. An item identifier 1705 is provided on one or more products or displays 1701. The item identifier can be any number or character or combination thereof that is unique to the product or display (or service associated with a display) or any other number that can be used to identify the product or display, for example, such as a bar code. A consumer transmits one or more images 1702 of the item identifier 1705 or transmits a text message containing the item identifier 1705 associated with one or more products/displays 1701 along with one or more images of a loyalty program number 1707 or a text message containing the loyalty program account number 1707 to a remote location 1703 by using a mobile device 1700. If it is determined that the transmission from the consumer is eligible for a reward 1704 (and if the one or more images of the item identifier meet predetermined criteria and/or if the loyalty program account number is valid), the remote location 1703 instantly transmits the reward 1704 to the consumer, for example, through the loyalty program 1706 by assigning the reward to the loyalty program account associated with the received loyalty program account number. The reward may be points in the loyalty program, one or more coupons, or, for example, a movie trailer to promote interest in a particular movie.

It will be recognized that the examples shown in FIGS. 15-17 could also be configured to receive an image of or a message containing a proof of purchase in lieu of, or in addition to, an item identifier.

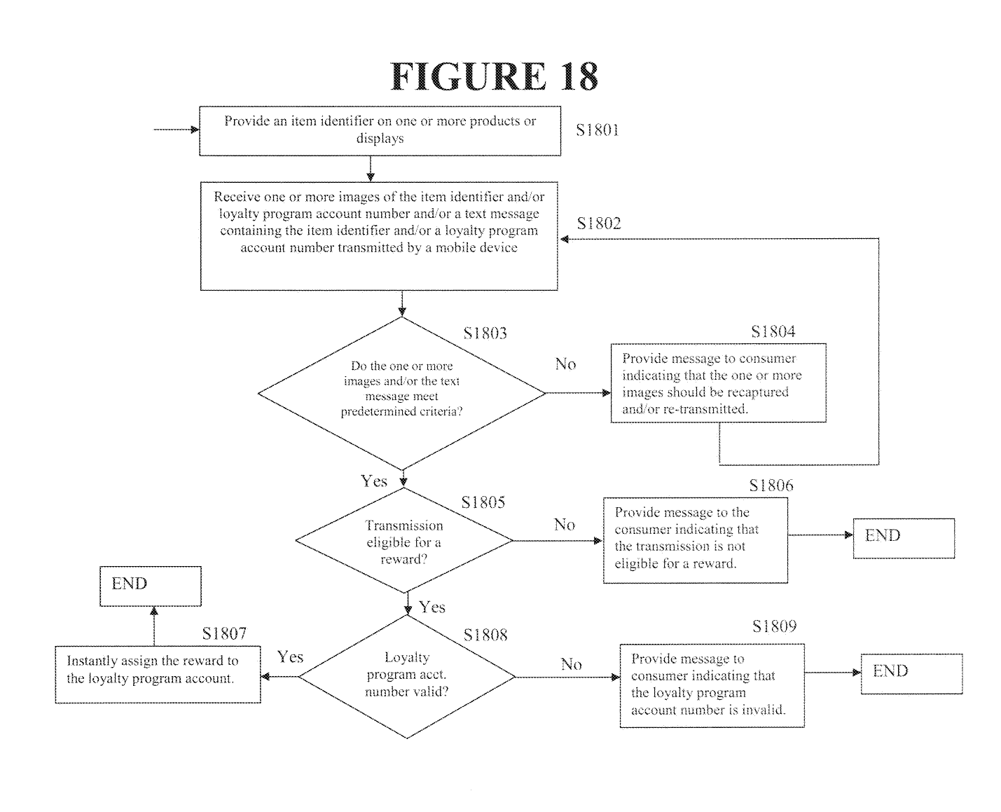

FIG. 18 is a flow chart illustrating a method for implementing a promotional reward program, according to an embodiment of the present disclosure. A unique transaction identifier, as a proof of purchase, is provided on a receipt for a transaction (Step S1801). A consumer may transmit one or more images of the unique transaction identifier and/or a text message containing the unique transaction identifier along with one or more images of a loyalty program account number or text message containing the loyalty program account number directly for verification to a remote location by using a mobile device (Step S1802). Once the unique transaction identifier is transmitted by the consumer through the mobile device along with the loyalty program account number to a remote location, it may be determined if the one or more images of the unique transaction identifier and/or the loyalty program account number and/or the text message containing the unique transaction identifier and the loyalty program account number meet predetermined criteria. (Step S1803). The consumer may transmit any combination of the following: one or more images of the unique transaction identifier along with a text message containing the loyalty program account number; one or more images of the unique transaction identifier and one or more images of the loyalty program account number, one or more images of the loyalty program account number and a text message containing the unique transaction identifier; or a text message containing both the unique transaction identifier and the loyalty program account number. This verification may be conducted by one or more of a computer or human operator. If it is determined that the one or more images of the unique transaction identifier and/or loyalty program number or the text message containing the unique transaction identifier and/or loyalty program account number do not meet predetermined criteria (No, Step S1803), for example, if the one or more images are not of a suitable resolution or if the text message containing the unique transaction identifier contains an incorrect number of digits, a message is transmitted to the consumer through the mobile device indicating that the one or more images should be re-captured and/or re-transmitted (Step S1804). The message also may indicate the reason that the one or more images are not, for example, of a suitable resolution. For example, the image may be too shadowy or the environment where the image is taken may not be adequately lit. Alternatively, if an electronic image recognition operation fails, before the message is sent, the image may be sent to a human operator who may manually verify that the one or more images of the unique transaction identifier do not meet the predetermined criteria, for example, are not a suitable resolution. If the images or text message does not meet the predetermined criteria, the method then loops back to Step S1802 and the process may start again.

In order to determine whether the transmission from the consumer is eligible for a reward (Step S1805), the method and system determines whether the contents of the transmission have met all of the eligibility criteria, for example, whether the transmission includes an image of a unique transaction identifier, such as a valid bar code (or has provided a unique transaction identifier, such as a valid bar code, via text message), whether it is an eligible unique transaction identifier, and/or whether the loyalty program account number is valid (Step S1808). If it is determined that the transmission is not eligible for a reward (No, Step S1805), a message is transmitted to the consumer indicating that the transmission is not eligible for a reward (Step S1806) and the process ends. If it is determined that the loyalty program account number is not valid (No, Step S1808), a message is provided to the consumer indicating that the loyalty program account number is invalid (Step S1809) and the process ends. If it is determined that the one or more images of the unique transaction identifier and/or the loyalty program account number or the text message containing the unique transaction identifier and/or loyalty program account number meet predetermined criteria and if the transmission is eligible for a reward and if the loyalty program account number is valid, (Yes, Steps S1803, S1805, S1808), the reward is instantly transmitted to the consumer through the customer loyalty program (Step S1807), for example, by assigning the reward to a loyalty program account corresponding to the loyalty program account number received from the consumer. According to an embodiment, the reward may be information about the product or a service comprising recipes, tips about how to use a product or obtain a service, or one or more coupons relating to the product or service. According to another embodiment, the reward may be a debit code associated with a predetermined value which may be usable to purchase one or more products or services, or may be a credit that can be applied to pay one or more of the consumer's bills. In order to redeem the reward, the consumer may utilize the loyalty program account number in connection with a purchase to which the reward may be applied.

It will be recognized that the example shown in FIG. 18 could also be configured to receive an image of or a message containing another type of proof of purchase or an item identifier in lieu of, or in addition to, a unique transaction identifier.

According to another embodiment, a promotional reward program may be implemented by a promotional reward program management apparatus. The management apparatus may comprise any one or more of the servers, kiosks, etc. described above, or may also include one or more different electronic apparatuses, such as a personal computer, dedicated reward server, et cetera.

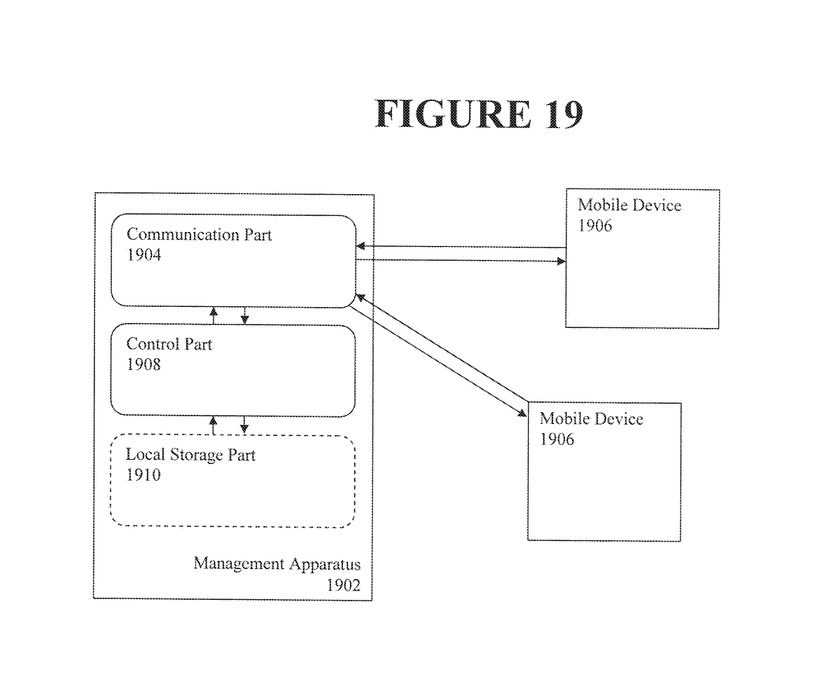

The management apparatus 1902, shown notionally in FIG. 19, may comprise a communication part 1904 configured to communicate with mobile devices 1906. The communication part 1904 may be configured to share data with mobile devices 1906 through any one or more networks and/or using any data sharing protocols known in the art. As an example, a communication part 1904 of a managing apparatus 1902 is configured to send and receive emails over the Internet. As another example, a communication part 1904 of a managing apparatus 1902 may be configured to send and receive text messages through cellular telephone voice and/or data networks.

The management apparatus 1902 may also include a control part 1908 for implementing any one or more of the various validation and determination steps of the various methods for implementing a promotional reward program described above. For example, the control part 1908 may be configured to determine if a received image of a proof of purchase meets one or more predetermined criteria. As another example, the control part 1908 may be configured to determine if a purchase meets one or more eligibility requirements for an award.

In another aspect, the management apparatus 1902 may optionally include a local storage part 1910 for storing information regarding past reward redemptions or attempted redemptions for use in determining eligibility for current and future reward requests.

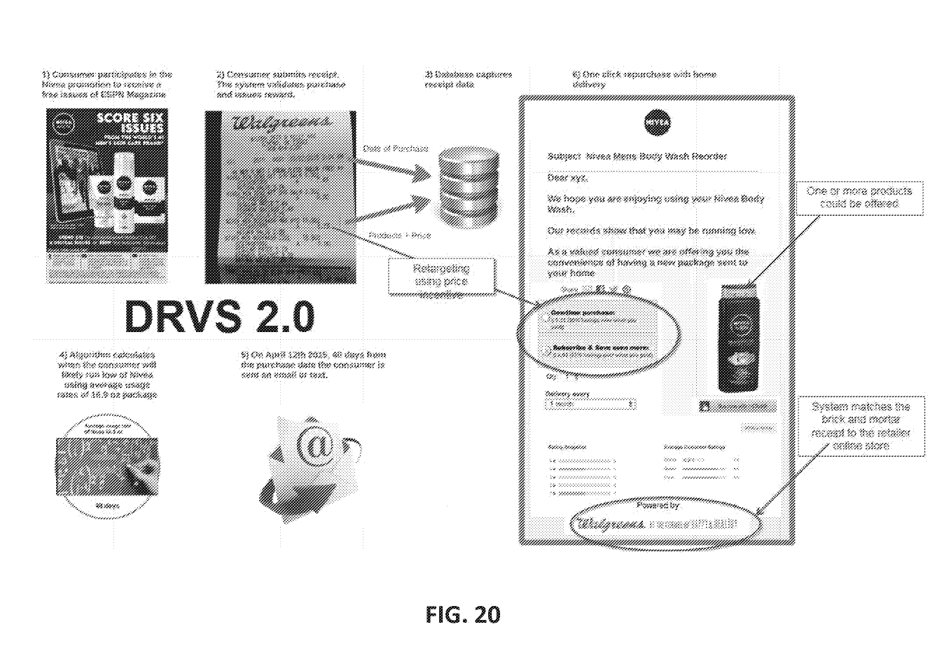

FIG. 20 shows a diagram of a system and method for implementing a promotional reward program according to an embodiment of the present disclosure. As illustrated in FIG. 20, a consumer may decide to participate in a promotional reward program by purchasing a predetermined product. After the consumer purchases the predetermined product, the consumer may transmit an image of a receipt showing proof of purchase of the predetermined product to a database. The image of the receipt may be transmitted, recognized, and/or verified in accordance with any of the previously disclosed embodiments.

The system may be configured to automatically input information obtained from the receipt into an algorithm and determine when the consumer will be likely to need the predetermined product. The information on the receipt that may automatically be input into and used by the algorithm may include, without limitation, the date and/or time of the purchase, the price of the predetermined product, the number of predetermined product purchased, the store where the predetermined product was purchased, and/or the size and/or quantity of the predetermined product purchased. In some embodiments, other factors about the consumer that may be stored in the database may additionally be automatically input into the algorithm, including without limitation, products purchased by the consumer and/or the number of times the consumer previously purchased the predetermined product and information associated with those purchases.

After the factors are automatically input into the algorithm, a processor connected to the database may be configured to determine the date the consumer will likely need the predetermined product and/or need to re-purchase the predetermined product (the “Re-purchase Date”). The system may be configured to store the Re-purchase Date in a database associated with the consumer and automatically transmit one or more promotional rewards to the consumer on the Re-purchase Date. The one or more promotional rewards may be related to the predetermined product, including without limitation, coupons for the predetermined product and/or coupons for the products or services related to the predetermined product. In some embodiments, the one or more promotional rewards may be for use online and/or in any store. In other embodiments, the one or more promotional rewards may be limited to use in the store (online or brick and mortar) where the predetermined product was originally purchased. For example, in some embodiments, transmission of the one or more promotional rewards may include a one-click purchase with a home delivery option. In those embodiments, the one or more promotional rewards may include an identifier, including without limitation, a logo of the store where the consumer purchased the predetermined product.

The embodiments disclosed herein may be configured to enable a consumer to use a mobile device to transmit an image of a receipt and/or the information on the receipt to a remote database. In some embodiments, the mobile device may be configured to scan a quick response (“QR”) code and/or be equipped with a near field communication (“NFC”) chip that may be configured to communicate with NFC tags. When a consumer uses the mobile device to scan or taps a product and/or advertisement having an NFC tag or a QR code, the consumer's mobile device may be configured to automatically display a website to which the consumer can upload the receipt. Alternatively, or in addition, in some embodiments, when a consumer scans or taps the mobile device to a product and/or advertisement having an NFC tag or a QR code, the consumer' mobile device may be configured to automatically display a notification that the consumer has instantly won a prize, information about the product and/or information related to the product, content based on the GPS location of the mobile device, content based on the number of times the consumer has scanned or tapped the product and/or advertisement, and content based on the last time and/or date the consumer scanned or tapped the product and/or advertisement.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

What is claimed is:

1. A method for implementing a promotional reward program system using a promotional management apparatus, the method comprising:
receiving, using a communication processor of the promotional program management apparatus, a proof of purchase of a product from a mobile device of a consumer;
extracting, using a control processor of the promotional program management apparatus, data from the proof of purchase;
determining, using the control processor of the promotional management apparatus, a target date associated with the product based on the extracted data;
recording in a database of the promotional program management apparatus the target date associated with the product;
associating in the database of the promotional program management apparatus the target date associated with the product to the consumer; and
transmitting, using the communication processor of the promotional program management apparatus, a promotional reward to the mobile device of the consumer on the target date.

2. The method of claim 1, wherein the proof of purchase includes a receipt.

3. The method of claim 2, wherein the proof of purchase includes an image of the receipt.

4. The method of claim 1, wherein the data includes at least one of a date of purchase, a time of purchase, a price of the product, a number of the product purchased, a size of the product, and a quantity of the product, and information regarding previous purchases of the product by the consumer.

5. The method of claim 1, wherein the promotional reward includes a coupon.

6. The method of claim 1, wherein the receiving step includes utilizing a quick response (QR) code.

7. The method of claim 1, wherein the receiving step includes transmitting or receiving information using a near-field communication (NFC) chip.

8. The method of claim 1, wherein the target date includes a target re-purchase date of the product.

9. A promotional reward program system, comprising:
a promotional program management apparatus including a memory, a processor, and a database, the promotional program management apparatus being configured to:
receive a proof of purchase of a product from a mobile device of a consumer;
extract data from the proof of purchase;
determine a target date associated with the product based on the extracted data;
record in the database the target date associated with the product;
associate in the database the target date associated with the product to the consumer; and
transmit a promotional reward to the mobile device of the consumer on the target date.

10. The system of claim 9, wherein the proof of purchase includes a receipt.

11. The system of claim 10, wherein the proof of purchase includes an image of the receipt.

12. The system of claim 9, wherein the data includes at least one of a date of purchase, a time of purchase, a price of the product, a number of the product purchased, a size of the product, and a quantity of the product, and information regarding previous purchases of the product by the consumer.

13. The system of claim 9, wherein the promotional reward includes a coupon.

14. The system of claim 9, wherein the system is further configured to utilize a quick response (QR) code.

15. The system of claim 9, wherein the system is further configured to transmit or receive information using a near-field communication (NFC) chip.

16. The system of claim 9, wherein the target date includes a target re-purchase date of the product.
